(19) United States
(12) Patent Application Publication
(10) Pub. No.: US 2007/0152424 A1
(43) Pub. Date: Jul. 5, 2007

(54) Vehicle-trailer low-speed offtracking control

(76) Inventors: Weiwen Deng, Rochester Hills, MI (US); Yong H. Lee, Troy, MI (US); Ming Tian, Mason, OH (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/313,164

(22) Filed: Dec. 20, 2005

(51) Int. Cl. B62D 53/06

(52) U.S. Cl. 280/432

(57) ABSTRACT

An offtracking control system for a vehicle/trailer combination that properly steers the rear wheels of the vehicle to control the hitch angle between the vehicle and the trailer to prevent trailer offtracking. The control system generates a desired hitch angle and a time delay between the front wheels of the vehicle and the rear wheels of the trailer. A delay unit generates a hitch angle command from the desired hitch angle and the time delay. The hitch angle command is subtracted from a measured hitch angle to generate a hitch angle error signal. The hitch angle error signal is sent to a feedback controller that generates a closed-loop rear-wheel steering signal. The closed-loop rear-wheel steering signal is added to an open-loop rear-wheel steering signal to generate a rear-wheel steering command signal that prevents trailer offtracking.

### BACKGROUND OF THE INVENTION

1. Field of the Invention

This invention relates generally to a system for providing vehicle/trailer offtracking control and, more particularly, to a system for providing low speed vehicle/trailer offtracking control that includes determining a desired hitch angle between the trailer and the vehicle and a variable time delay between the vehicle front wheels and the trailers rear wheels to provide hitch angle feedback and closed-loop rear-wheel steering control.

2. Discussion of the Related Art

It is known in the art to employ active rear-wheel vehicle steering based on vehicle dynamic information during a vehicle turn, or yaw. Active rear-wheel steering control can improve vehicle stability over a conventional vehicle having only two steerable front wheels. The rear-wheel steering control can be in-phase steering or out-of-phase steering. In-phase rear-wheel steering steers the rear wheels in the same direction as the front wheels, and is typically provided at higher vehicle speeds. Out-of-phase rear-wheel steering steers the rear wheels in an opposite direction to the front wheels to provide a tighter turning radius, and is typically provided at lower vehicle speeds.

Open-loop (feed-forward) rear-wheel steering control provides a predetermined amount of rear-wheel steering control depending on the amount of hand-wheel steering provided by the vehicle operator and the vehicle speed. It is known to also provide closed-loop feedback rear-wheel steering based on certain feedback signals in the event that the vehicle is not following what is requested by the vehicle operator. Closed-loop rear-wheel steering assist systems sense the actual vehicle yaw rate and the intended yaw rate, and generate an error signal that provides the steering control by the rear wheels if the actual vehicle yaw rate and the intended vehicle yaw rate are not the same.

It is well known that when a vehicle travels around a corner, the rear wheels of the vehicle follow a different path than the front wheels of the vehicle. This phenomenon is known in the art as offtracking. Offtracking is more of a problem for a vehicle pulling a trailer where the trailer wheels do not follow the same path as the wheels of the towing vehicle. Typically at low vehicle speeds, for example speeds under 40 kph, the trailer wheels follow a path closer to the inside curve of the turn. For longer trailers, the offtracking is more serious. Offtracking sometimes requires that the vehicle operator make a wider turn than is desired to prevent the trailer wheels from colliding with curbs or other obstacles, especially when the vehicle and trailer are heavily loaded.

### SUMMARY OF THE INVENTION

In accordance with the teachings of the present invention, an offtracking control system for a vehicle/trailer combination is disclosed that properly steers the rear wheels of the vehicle to control the hitch angle between the vehicle and the trailer to prevent trailer offtracking. The control system uses a vehicle speed sensor, a vehicle yaw rate sensor, a hand-wheel angle sensor and a hitch angle sensor. The control system generates a desired hitch angle and a travel time delay between the front wheels of the vehicle and the rear wheels of the trailer from the sensor signals. A delay unit generates a hitch angle command from the desired hitch angle and the time delay. The hitch angle command is subtracted from the sensed hitch angle to generate a hitch angle error signal. The hitch angle error signal is sent to a feedback controller that generates a closed-loop rear-wheel steering signal. The closed-loop rear-wheel steering signal is added to an open-loop rear-wheel steering signal to generate a rear-wheel steering command signal that prevents trailer offtracking.

Additional advantages and features of the present invention will become apparent from the following description and appended claims, taken in conjunction with the accompanying drawings.

### BRIEF DESCRIPTION OF THE DRAWINGS

FIG. 1 is a plan view of a vehicle/trailer combination that includes a control system for providing active rear-wheel steering to prevent trailer offtracking, according to an embodiment of the present invention;

FIG. 2 is a tricycle model of a vehicle/trailer combination used to provide the calculations of the control system;

FIG. 3 is a block diagram of a rear-wheel steering control system for preventing trailer offtracking, according to an embodiment of the present invention; and

FIG. 4 is a flow chart diagram showing a process for using rear-wheel steering to prevent trailer offtracking, according to an embodiment of the present invention.

### DETAILED DESCRIPTION OF THE EMBODIMENTS

The following discussion of the embodiments of the invention directed to active rear-wheel steering control for a vehicle/trailer combination to prevent or reduce trailer offtracking is merely exemplary in nature, and is in no way intended to limit the invention or its applications or uses.

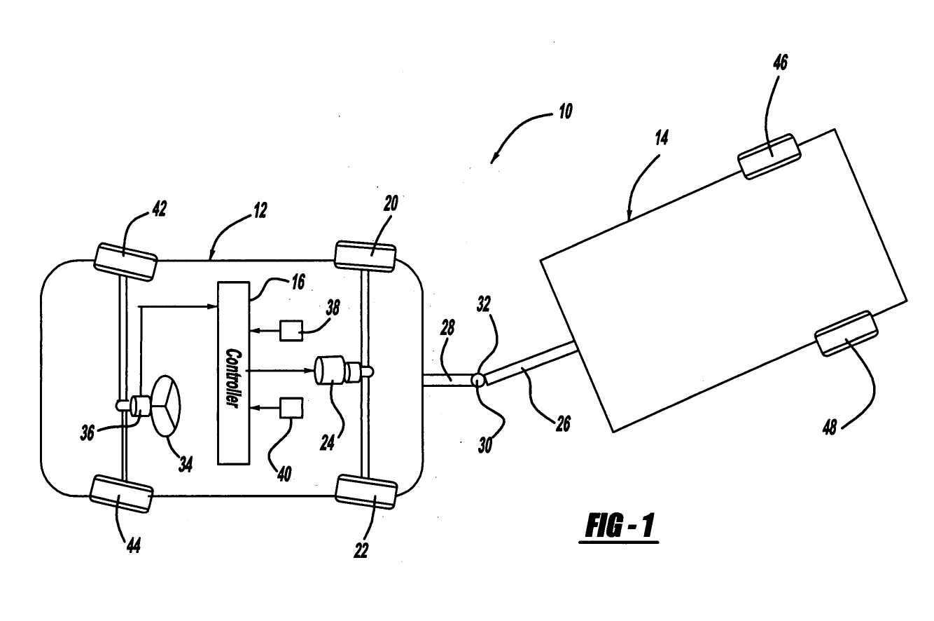

FIG. 1 is a plan view of a vehicle/trailer combination 10 including a vehicle 12 and a trailer 14. The vehicle 12 includes a controller 16 that provides active rear-wheel steering control to rear wheels 20 and 22 through an electric motor 24. The trailer 14 includes a trailer hitch post 26 and the vehicle 12 includes a vehicle hitch post 28 including a hitch 30. A hitch angle sensor 32 measures the hitch angle between the vehicle 12 and the trailer 14. The vehicle 12 also includes a hand-wheel 34 for steering front wheels 42 and 44 of the vehicle 12. A hand-wheel angle sensor 36 measures the angle of the hand-wheel 34 and provides a hand-wheel angle signal to the controller 16 indicative of the desired turning radius of the vehicle 12. The vehicle 12 further includes a vehicle speed sensor 38 for providing a vehicle speed signal to the controller 16 of the speed of the vehicle 12, and a vehicle yaw rate sensor 40 for providing a vehicle yaw rate signal to the controller 16 of the yaw rate of the vehicle 12. The sensors 32, 36, 38 and 40 can be any sensor that is suitable for the purpose discussed herein.

As will be discussed in detail below, the controller 16 provides a rear-wheel steering command to prevent trailer offtracking during a turn. The steering command is a combination of an open-loop steering command and a closed-loop steering command. The open-loop steering command is provided by a look-up table based on the speed of the vehicle and the hand-wheel angle or front wheel steering angle, as is well understood in the art. The open-loop steering command table will be different depending on whether the vehicle 12 is towing the trailer 14 or not. The closed-loop steering command is determined by the yaw rate of the vehicle 12, the speed of the vehicle 12, the hand-wheel angle and the hitch angle between the vehicle 12 and the trailer 14. Suitable sensors (not shown) can be used to determine if the trailer 14 is attached to the vehicle 12 so that the closed-loop steering control to prevent offtracking is engaged. Alternately, the vehicle operator can turn a switch (not shown) to engage and disengage the closed-loop steering control. Also, the closed-loop steering control can be determined differently for stability purposes when the trailer 14 is not attached to the vehicle 12.

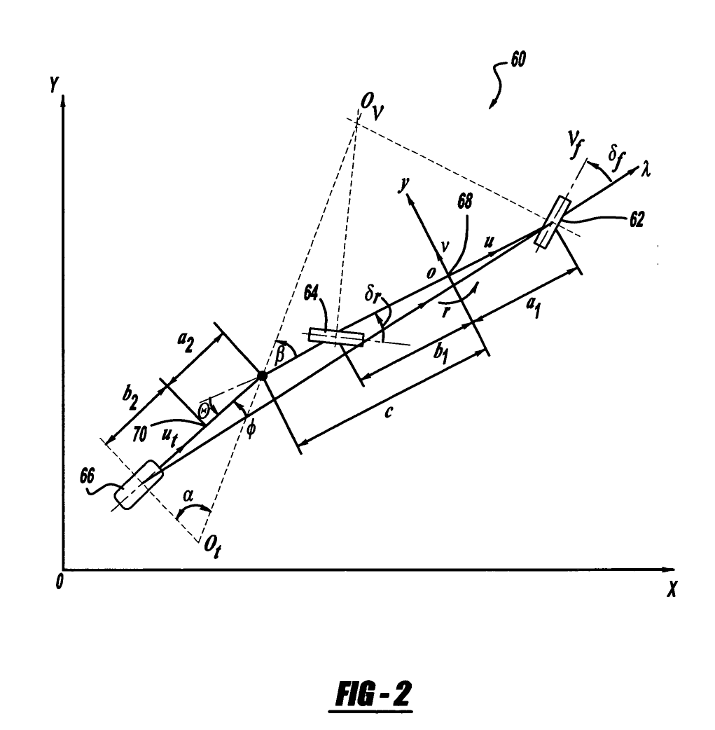

To calculate the closed-loop steering control referred to above, the vehicle/trailer combination 10 is modeled as a tricycle model 60 as shown in FIG. 2, where wheel 62 represents the front wheels 42 and 44 of the vehicle 12, wheel 64 represents the rear wheels 20 and 22 of the vehicle 12, wheel 66 represents the rear wheels 46 and 48 of the trailer 14, point 68 is the center of gravity of the vehicle 12 and point 70 is the center of gravity of the trailer 14.

To prevent the trailer offtracking the present invention proposes maintaining the rear wheels 46 and 48 of the trailer 14 at the same turning radius R as the front wheels 42 and 44 of the vehicle 12 over Δt seconds when negotiating a tight turn at low speeds. In other words, the control system uses the rear-wheel steering to adjust the hitch angle between the vehicle 12 and the trailer 14 during the time it takes the rear wheels of the trailer 14 to reach a previous position of the front wheels of the vehicle 12 during a turn.

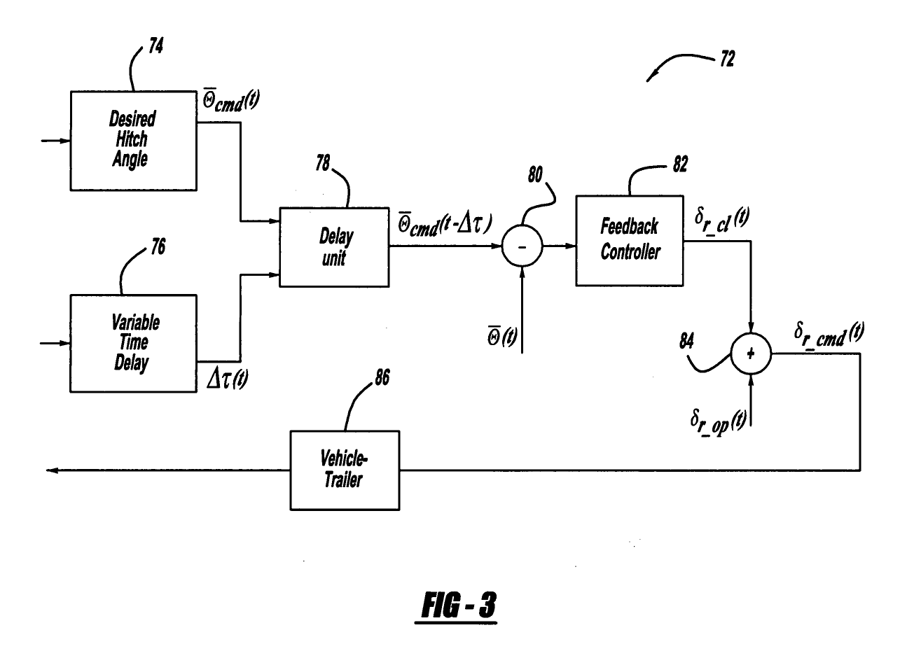

FIG. 3 is a block diagram of a trailer offtracking control system 72, according to an embodiment of the present invention. The control system 72 includes a desired hitch angle sub-system 74 and a variable time delay sub-system 76 that are responsive to the vehicle speed signal u from the vehicle speed sensor 38, the yaw rate signal r from the vehicle yaw rate sensor 40, the hand-wheel angle signal 6 from the hand-wheel angle sensor 36 and the hitch angle signal 0 from the hitch angle sensor 32. The hitch angle sub-system 74 generates a desired hitch angle θ_{cmd}(t). The desired hitch angle θ_{cmd}(t) is the hitch angle between the vehicle 12 and the trailer 14 that causes the trailer 14 to achieve the turning radius R of the vehicle 12. The variable time delay sub-system 76 generates a variable time delay signal Δτ(t) that is the time it takes the rear wheels 46 and 48 of the trailer 14 to reach the current position of the front wheels 42 and 44 of the vehicle 12.

The desired hitch angle θ_{cmd}(t) required to maintain the turning radius R with the time delay Δτ(t) between the front wheels 42 and 44 of the vehicle 12 and the rear wheels 46 and 48 of the trailer 14 are determined as follows in one embodiment. The vehicle turning radius R with four-wheel steering can be calculated as:

$$\begin{matrix}R = \frac{sin ( \frac{π}{2} + {δ}_{r} )}{sin ( {δ}_{f} - {δ}_{r} )} ( {a}_{1} + {b}_{1} ) \\ = \frac{cos ( {δ}_{r} )}{sin ( {δ}_{f} - {δ}_{r} )} ( {a}_{1} + {b}_{1} )\end{matrix} \qquad ( 1 )$$

Where a₁ is the distance from the vehicle's front axle to its center of gravity, b₁ is the distance from the center of gravity to the vehicle's rear axle, δ_{f} and δᵣ are the front and rear wheel angles, respectively.

The total velocity at the hitch 30 is:

$${V}_{h} = \frac{u}{cos β} = \sqrt{{u}^{2} + {( v - rc )}^{2}} \\ Where β = {cos}^{- 1} ( \frac{u}{\sqrt{{u}^{2} + {( v - rc )}^{2}}} ) \qquad ( 2 )$$

From triangulation:

$$sin α = \frac{R}{\sqrt{{R}^{2} + {( {a}_{2} + {b}_{2} )}^{2}}} = \frac{1}{\sqrt{1 + {( \frac{{a}_{2} + {b}_{2}}{R} )}^{2}}} \\ α = {sin}^{- 1} ( \frac{1}{\sqrt{1 + {( \frac{{a}_{2} + {b}_{2}}{R} )}^{2}}} ( 3 ) \qquad ( 3 )$$

Thus, the desired hitch angle θ_{cmd}(t) can be calculated as:

$$\begin{matrix}{\overline{θ}}_{cmd} ( t ) = α + β - \frac{π}{2} \\ = {sin}^{- 1} ( \frac{1}{\sqrt{1 + {( \frac{{a}_{2} + {b}_{2}}{R} )}^{2}}} ) + \\ {cos}^{- 1} ( \frac{u}{\sqrt{{u}^{2} + {( v - rc )}^{2}}} ) - \frac{π}{2}\end{matrix} \qquad ( 4 )$$

To approximate the variable time delay Δτ between the vehicle's front wheels 42 and 44 and the trailer's rear wheels 46 and 48, the equivalent trailer travel distance d_{eq} can be calculated as:

$$\begin{matrix}{d}_{eq} = \sqrt{{( {a}_{1} + c )}^{2} + {( {a}_{2} + {b}_{2} )}^{2} - 2 ( {a}_{1} + c ) ( {a}_{2} + {b}_{2} ) cos ( π - θ )} \\ = \sqrt{{l}_{1}^{2} + {l}_{2}^{2} - 2 {l}_{1} {l}_{2} cos ( π - θ )}\end{matrix} \qquad ( 5 )$$

Where l₁=a₁+c and l₂=a₂+b₂.

The equivalent trailer traveling speed u_{eq} at the rear wheels 46 and 48 of the trailer 14 is approximated as:

$$\begin{matrix}{u}_{eq} = [ u cos θ + ( v - rc ) \cdot sin θ ] \cdot cos φ \\ \approx ( u cos θ - rc \cdot sin θ ) \cdot cos φ\end{matrix} \\ Δτ = \frac{{d}_{eq}}{{u}_{eq}} = \frac{{l}_{1}^{2} + {l}_{2}^{2} - 2 {l}_{1} {l}_{2} cos ( π - θ )}{[ {l}_{2} - {l}_{1} \cdot cos ( π - θ ] \cdot {u}_{t}} \qquad ( 6 )$$

The desired hitch angle signal θ_{cmd}(t) and the time delay signal Δτ are sent to a delay unit 78 that generates a hitch angle command signal θ_{cmd}(t−Δτ). The hitch angle command signal θ_{cmd}(t−Δτ) can be determined by a transport delay as:
θ_{cmd}(t)= θ̅_{cmd}(t−Δτ) (7)

The hitch angle command signal θ_{cmd}(t−Δτ) is subtracted from the measured hitch angle θ(t) received from the sensor 32 in a differencer 80 to generate a hitch angle error signal. The hitch angle error signal is sent to a feedback controller 82, for example a proportional-integral-derivative (PID) controller, that generates a closed-loop rear-wheel steering (RWS) command signal δᵣ_{₁₃} _{cl}(t). The RWS command signal can be determined through a PID feedback control as:
Δθ(t)=θ_{cmd}(t)−θ(t) (8)

The RWS closed-loop command signal is determined as:

$${\overline{δ}}_{r\_cl} = ( {K}_{p} Δθ + {K}_{i} \int Δθ ⅆ t + {K}_{d} \frac{ⅆ Δθ}{ⅆ t} ) \qquad ( 9 )$$

Where Kₚ, Kᵢ and K_{d} are the proportional, integral and derivative gains, respectively.

The closed-loop rear-wheel steering command signal δᵣ_{₁₃} _{cl}(t) is added to the open-loop rear-wheel steering command signal δᵣ_{_{—}}ₒₚ(t) in an adder 84 that provides the RWS command signal δᵣ_{_{—}}_{cmd}(t) that controls the rear wheel steering of the vehicle in a vehicle/trailer combination 86 to prevent the trailer offtracking. The total rear-wheel steering steering command δᵣ_{_{—}}_{cmd}(t) is thus the summation of both the open-loop command δᵣ_{_{—}}ₒₚ(t) and the closed-loop feed-back command δᵣ_{₁₃} _{cl}(t) as:
δ̅ᵣ_{_{—}}_{cmd}= δ̅ᵣ_{_{—}}ₒₚ+ δ̅ᵣ_{_{—}}_{cl} (10)

The closed-loop offtracking control only works when the RWS open-loop control gain is negative, i.e., the rear-wheel steering angle command is out-of-phase with the front wheel angle.

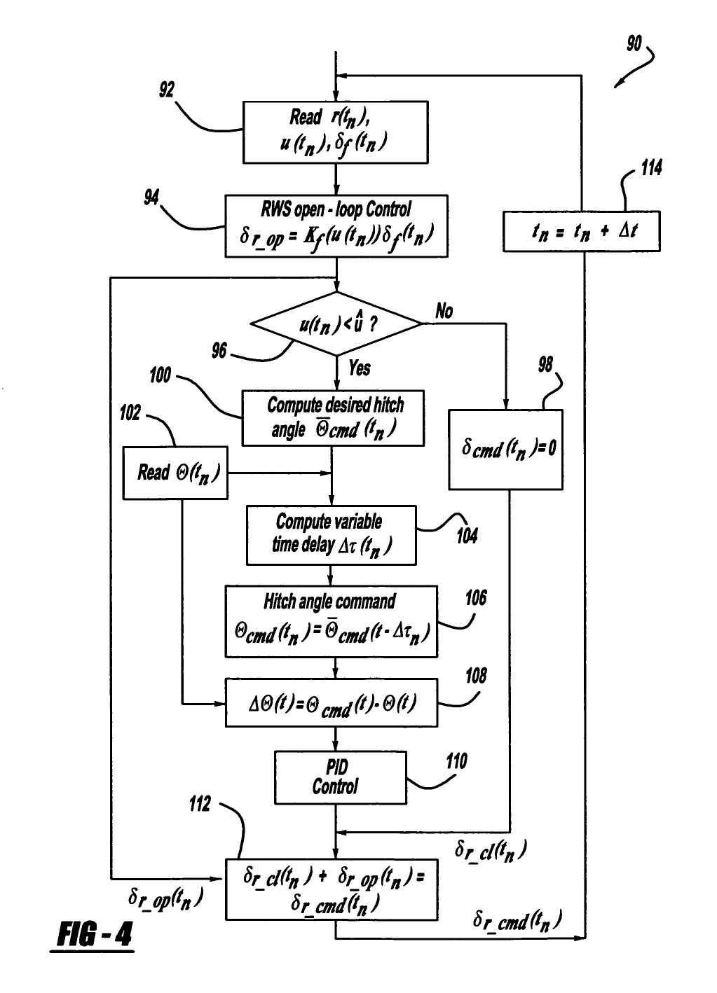

FIG. 4 is a flow chart diagram 90 showing one process for preventing offtracking in the vehicle/trailer combination 86 as discussed above. The algorithm reads the sensor signals at box 92 including the vehicle speed u(t), the hand-wheel angle δ_{f}(t) and the vehicle yaw rate r(t). The algorithm then computes the RWS opened-loop command δᵣ_{_{—}}ₒₚ(t) at box 94 as:
δ̅ᵣ_{_{—}}ₒₚ=K_{f}(u(tₙ)) δ̅_{f}(tₙ) (11)

The algorithm then determines whether the vehicle speed signal u(t) is less than a predetermined vehicle speed value û where no offtracking control is needed or used at decision diamond 96. The speed value û can be set at a crossover speed where the rear-front steering ratio of the RSW opened-loop control changes sign from in-phase steering to out-of-phase steering, such as 40 kph. If the vehicle speed signal u(t) is greater than or equal to the predetermined speed value û, then no offtracking control is necessary and the closed-loop rear-wheel steering command δ_{r-cl}(t) is set to zero at box 98.

If the vehicle speed signal u(t) is less than the predetermined speed value û, then the algorithm computes the desired hitch angle θ̅_{cmd}(t) at box 100 in the sub-system 74. The algorithm then reads the sensor signal θ(t) from the hitch angle sensor 32 at box 102. The algorithm then computes the variable time delay Δτ(t) between the front wheels 42 and 44 of the vehicle 12 and the rear wheels 46 and 48 of the trailer 14 at box 104 in the sub-system 76. The algorithm then determines the hitch angle command θ̅_{cmd}(t) at box 106 in the delay unit 78 as:
θ_{cmd}(t)= θ̅_{cmd}(t−Δτ) (12)

The hitch angle command θ_{cmd}(tₙ) is then subtracted from the measured hitch angle θ(t) at box 108 to generate a hitch angle error as:
Δθ(t)=θ_{cmd}(t)−θ(t) (13)

The algorithm then determines the corresponding RWS closed-loop offtracking control command from equation (9) by the feedback controller 82 at box 110. The total RWS control command δᵣ_{_{—}}_{cmd}(t) is provided as the sum of both the opened-loop command δᵣ_{_{—}}ₒₚ(t) and the closed-loop command δᵣ_{_{—}}_{cl}(t) at box 112. The system clock is then updated at box 114, and the algorithm returns to reading the sensor signals at box 92.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A control system for preventing offtracking of a trailer being towed by a vehicle, said system comprising:
a vehicle speed sensor for providing a signal of the speed of the vehicle;
a vehicle yaw rate sensor for providing a signal of the yaw rate of the vehicle;
a hand-wheel angle sensor for providing a signal of the angle of a vehicle hand-wheel;
a hitch angle sensor for providing a signal of the measured hitch angle between the vehicle and the trailer;
a desired hitch angle sub-system responsive to the vehicle speed signal, the vehicle yaw rate signal, the hand-wheel angle signal and the measured hitch angle signal, said hitch angle sub-system generating a desired hitch angle signal;
a variable time delay sub-system responsive to the vehicle speed signal, the vehicle yaw rate signal, the hand-wheel angle signal and the hitch angle signal, said variable time delay sub-system generating a time delay signal between front wheels of the vehicle and rear wheels of the trailer;
a hitch angle command sub-system responsive to the desired hitch angle signal and the time delay signal, said hitch angle command sub-system generating a hitch angle command;
a differencer responsive to the hitch angle command and the measured hitch angle signal, said difference generating a hitch angle error signal; and
a controller responsive to the error signal, said controller generating a closed-loop rear-wheel steering signal.

2. The system according to claim 1 further comprising an adder, said adder being responsive to the closed-loop rear-wheel steering signal and an open-loop rear-wheel steering signal, said adder generating a rear-wheel steering command signal for steering rear wheels of the vehicle that prevents the offtracking.

3. The system according to claim 1 wherein the controller is a proportional-integral-derivative (PID) controller.

4. The system according to claim 1 wherein the system only prevents trailer offtracking for vehicle speeds less than a predetermined vehicle speed.

5. The system according to claim 4 wherein the predetermined vehicle speed is about 40 kph.

6. A control system for preventing offtracking of a trailer being towed by a vehicle, said system comprising:
a desired hitch angle sub-system for generating a desired hitch angle signal;
a variable time delay sub-system for generating a time delay signal between the vehicle and the trailer; and
a hitch angle command sub-system responsive to the desired hitch angle signal and the time delay signal, said hitch angle command sub-system generating a hitch angle command that is used to prevent the trailer offtracking.

7. The system according to claim 6 further comprising a vehicle speed sensor for providing a signal of the speed of the vehicle, a vehicle yaw rate sensor for providing a signal of the yaw rate of the vehicle, a hand-wheel angle sensor for providing a signal of the angle of a vehicle hand-wheel, and a hitch angle sensor for providing a signal of the measured hitch angle between the vehicle and the trailer, wherein the desired hitch angle sub-system and the variable time delay sub-system are responsive to the vehicle speed signal, the vehicle yaw rate signal, the hand-wheel angle signal and the measured hitch angle signal.

8. The system according to claim 6 further comprising a differencer responsive to the hitch angle command and the measured hitch angle signal, said difference generating a hitch angle error signal.

9. The system according to claim 8 further comprising a controller responsive to the error signal, said controller generating a closed-loop rear-wheel steering signal.

10. The system according to claim 9 further comprising an adder, said adder being responsive to the closed-loop rear-wheel steering signal and an open-loop rear-wheel steering signal, said adder generating a rear-wheel steering command signal for steering rear wheels of the vehicle that prevents the offtracking.

11. The system according to claim 9 wherein the controller is a proportional-integral-derivative (PI D) controller.

12. The system according to claim 6 wherein the system only prevents trailer offtracking for vehicle speeds less than a predetermined speed.

13. The system according to claim 6 wherein the time delay sub-system generates the time delay signal between front wheels of the vehicle and rear wheels of the trailer.

14. A method for preventing offtracking of a trailer being towed by a vehicle, said method comprising:
generating a desired hitch angle signal;
generating a time delay signal between the vehicle and the trailer; and
generating a hitch angle command from the desired hitch angle signal and the time delay signal that is used to prevent the trailer offtracking.

15. The method according to claim 14 wherein generating a desired hitch angle signal and generating a time delay signal between the vehicle and the trailer includes using a measured vehicle speed, a measured vehicle yaw rate, a measured hand-wheel angle and a measured hitch angle.

16. The method according to claim 14 further comprising generating a hitch angle error signal between the hitch angle command and a measured hitch angle.

17. The method according to claim 16 further comprising generating a closed-loop rear-wheel steering signal from the error signal.

18. The method according to claim 17 further comprising generating a rear-wheel steering command signal for steering rear wheels of the vehicle that prevents the offtracking by adding the closed-loop rear-wheel steering signal and an open-loop rear-wheel steering signal.

19. The method according to claim 14 wherein the method only prevents trailer offtracking for vehicle speeds less than a predetermined speed.

20. The method according to claim 14 wherein generating a time delay signal between the vehicle and the trailer includes generating the time delay signal between front wheels of the vehicle and rear wheels of the trailer.
